(19) United States
(12) Patent Application Publication
(10) Pub. No.: US 2026/0319450 A1
(43) Pub. Date: Oct. 15, 2026

(54) BUILDING MANAGEMENT SYSTEM WITH SERVER REDUNDANCY

(71) Applicant: Tyco Fire & Security GmbH, Neuhausen am Rheinfall (CH)

(72) Inventors: Gregory B. Cebasek, New Berlin, WI (US); Ahmad Khalid, Qadian (IN); Vinod Saluja, Gurugram (IN); Jonathan M. Schwabe, Muskego, WI (US); Nikhil Sehgal, Gurugram (IN); Charles C. Xing, New Berlin, WI (US)

(73) Assignee: Tyco Fire & Security GmbH, Neuhausen am Rheinfall (CH)

(21) Appl. No.: 19/711,844

(22) Filed: Jun. 17, 2026

Related U.S. Application Data
(63) Continuation of application No. 19/683,496, filed on May 20, 2026.
(63) Continuation-in-part of application No. 19/274,350, filed on Jul. 18, 2025.
(60) Provisional application No. 63/788,641, filed on Apr. 14, 2025.

(51) Int. Cl. G05B 19/042

(52) U.S. Cl. CPC G05B 19/042; G05B 2219/2614

(57) ABSTRACT

A building management system is provided. The building management system includes a first server, a second server communicably coupled with the first server, and a client device communicably coupled with the first server and the second server. The first server is configured to provide a plurality of building management services. The second server is configured to provide redundant instances of the plurality of building management services while suppressing one or more outputs of the redundant instances. The second server is further configured to determine the first server is inactive. The second server is further configured to unsuppress the one or more outputs of the redundant instances in response to determining the first server is inactive. The client device is configured to transmit service requests for the plurality of building management services to the first server and the second server.

### CROSS-REFERENCE TO RELATED PATENT APPLICATION

This application claims the benefit of and priority to U.S. Provisional Application No. 63/788,641, filed Apr. 14, 2025, the entire disclosure of which is incorporated by reference herein.

### BACKGROUND

The present disclosure relates generally to building management systems. The present disclosure relates more particularly to a high availability building management system with redundant building management servers.

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include METASYS® building controllers or other devices sold by Johnson Controls, Inc., as well as building devices and components from other sources.

A BMS may include one or more computer systems (e.g., servers, BMS controllers, etc.) that serve as enterprise level controllers, application or data servers, head nodes, master controllers, or field controllers for the BMS. Such computer systems may communicate with multiple downstream building systems or subsystems (e.g., an HVAC system, a security system, etc.) according to like or disparate protocols (e.g., LON, BACnet, etc.). The computer systems may also provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

### SUMMARY

One implementation of the present disclosure relates to a building management system. The building management system includes a first server, a second server communicably coupled with the first server, and a client device communicably coupled with the first server and the second server. The first server is configured to provide a plurality of building management services. The second server is configured to provide redundant instances of the plurality of building management services while suppressing one or more outputs of the redundant instances. The second server is further configured to determine the first server is inactive. The second server is further configured to unsuppress the one or more outputs of the redundant instances in response to determining the first server is inactive. The client device is configured to transmit service requests for the plurality of building management services to the first server and the second server.

In some implementations, the client device is configured to obtain operational data generated by a building management subsystem operable to affect one or more conditions of a building. In some implementations, the client device is building equipment operable to control one or more controlled component of the building management subsystem to affect the one or more conditions of the building. In some implementations, the first server is configured to periodically transmit to the second server a status indicator. The second server is configured to receive the status indicator, determine an elapsed time since the status indicator was received, and determine the first server is inactive based on the elapsed time exceeding a threshold. In some implementations, the second server is further configured to transmit an alert to a user device in response to determining the first server is inactive. In some implementations, the plurality of building management services includes at least one of providing a user interface on a user device, monitoring a status of the client device, receiving historical data from the client device, providing alarms to an external system, generating a scheduled report, or configuring the client device. In some implementations, the one or more outputs include at least one of a scheduled report, an alarm to an external system, or a client device configuration. In some implementations, the building management system includes a third server communicably coupled with the first server, the second server, and the client device. The third server is configured to provide second redundant instances of the plurality of building management services while suppressing one or more outputs of the second redundant instances. The third server is further configured to determine the first server and the second server are inactive. The third server is further configured to unsuppress the one or more outputs of the second redundant instances in response to determining the first server and the second server are inactive.

One implementation of the present disclosure relates to a method of providing high availability building management. The method includes providing redundant instances of a plurality of building management services at a secondary server concurrently with a primary server. The method further includes suppressing one or more outputs of the redundant instances at the secondary server. The method further includes determining the primary server is inactive. The method further includes unsuppressing the one or more outputs of the redundant instances at the secondary server in response to determining the primary server is inactive.

In some implementations, determining the primary server is inactive includes receiving a status indicator from the primary server, determining an elapsed time since receiving the status indicator from the primary server, and determining the primary server is inactive in response to the elapsed time exceeding a threshold time. In some implementations, the method further includes transmitting, to a user device, an alert in response to determining the primary server is inactive. In some implementations, the plurality of building management services includes at least one of providing a user interface to a user device, providing alerts to the user device, monitoring a status of a client device, receiving historical data from the client device, providing an alarm to an external system, generating a scheduled report, or configuring the client device.

In some implementations, the one or more outputs includes one of an alarm to an external system, a scheduled report, or a client device configuration.

One implementation relates to a building management system including a secondary server. The secondary server includes one or more processors and a memory storing instructions, that when executed by the one or more processors, cause the one or more processors to perform first operations. The first operations include providing redundant instances of a plurality of building management services concurrently with a primary server. The first operations further include suppressing one or more outputs of the redundant instances. The first operations further include determining the primary server is inactive. The first operations further include unsuppressing the one or more outputs of the redundant instances in response to determining the primary server is inactive.

In some implementations, determining the primary server is inactive includes receiving a status indicator from the primary server, determining an elapsed time since receiving the status indicator from the primary server, and determining the primary server is inactive in response to the elapsed time exceeding a threshold time. In some implementations, the first operations further include transmitting, to a user device, an alert in response to determining the primary server is inactive. In some implementations, the plurality of building management services includes at least one of providing a user interface to a user device, providing alerts to the user device, monitoring a status of a client device, receiving historical data from the client device, providing an alarm to an external system, generating a scheduled report, or configuring the client device. In some implementations, the one or more outputs includes at least one of an alarm to an external system, a scheduled report, or a client device configuration. In some implementations, the building management system further includes a client device. The client device includes one or more processors and a memory storing instructions that, when executed by the one or more processors, cause the one or more processors to perform second operations. The second operations include transmitting service requests for the plurality of building management services to the primary building management controller and the secondary building management controller. In some implementations, the second operations further include obtaining operational data generated by a building management subsystem configured to affect one or more conditions of a building. In some implementations, the second operations further include controlling one or more controlled component of the building management subsystem to affect the one or more conditions of the building.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a BMS that serves the building of FIG. 1, according to some embodiments.

FIG. 3 is a block diagram of a BMS controller which can be used in the BMS of FIG. 2, according to some embodiments.

FIG. 4 is another block diagram of the BMS that serves the building of FIG. 1, according to some embodiments.

FIG. 5 is a schematic illustration of a building management system, according to some embodiments.

FIG. 6 is a block diagram of the building management system of FIG. 1, according to some embodiments.

FIG. 7 is a block diagram of a client device which can be used in the building management system of FIG. 1, according to some embodiments.

FIG. 8 is a block diagram of a server which can be used in the building management system of FIG. 1, according to some embodiments.

FIG. 9 is a flow diagram of a method for supervising and controlling building subsystems, which can be performed by the client device of FIG. 7, according to some embodiments.

FIG. 10 is a flow diagram of a method for providing high availability building management, which can be performed by the server of FIG. 8, according to some embodiments.

### DETAILED DESCRIPTION

### Overview

A building management system can include various building management subsystems, each operable to monitor and control various mechanical and electrical systems within a building. A building management system can include multiple supervisory controllers to cooperatively control and monitor multiple building subsystems. A building management system can include a building management server to act as a whole site director and data repository for the multiple supervisory controllers and their corresponding building management subsystems. A failure of the building management server may result in service disruption, data loss, and user/building occupant inconvenience while the building management server is being repaired, replaced, or while data, applications, and services are migrated to a redundant server.

Referring generally to the FIGURES, a high availability building management system with redundant building management servers is provided, according to various exemplary embodiments. The building management system includes at least two building management servers, each communicably coupled with one or more client devices (e.g., building subsystem supervisory controllers). A first one of the building management servers can act as primary server and is configured to provide a plurality of building management services. A second one of the building management servers can act as a redundant, or secondary server, and is configured to provide redundant instances of the plurality of building management services while suppressing one or more outputs of the redundant instances that may result in discordant or undesirable system behavior if duplicated. In the event that the primary server fails, the secondary server is configured to detect the failure and unsuppress the one or more suppressed outputs. The building management system can include a greater number of similarly configured building management server to provide a greater degree of redundancy. Accordingly, the building management system provided herein accommodates building management server failure without resulting in the downtime and inconvenience that would otherwise accompany server failure.

### Building and Building Management System

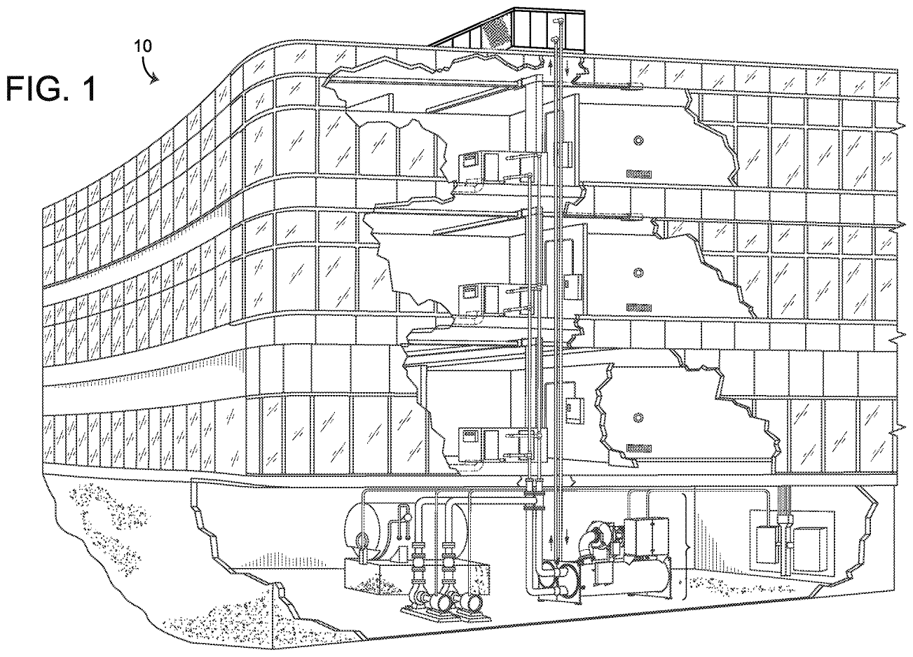

Referring now to FIG. 1, a perspective view of a building 10 is shown, according to an exemplary embodiment. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device” and “building equipment” are used interchangeably throughout this disclosure.

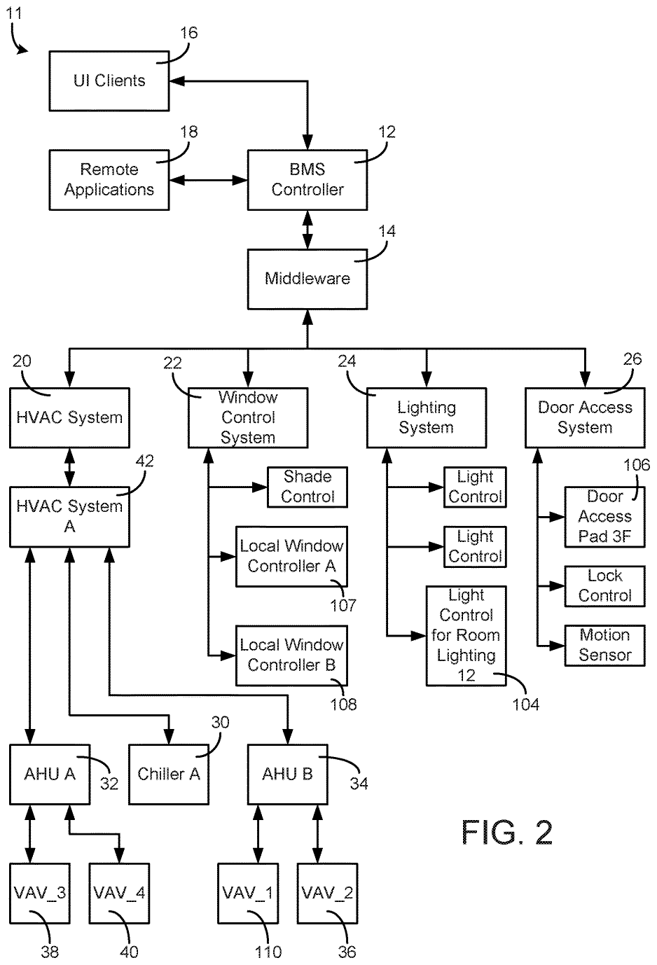

Referring now to FIG. 2, a block diagram of a BMS 11 for building 10 is shown, according to an exemplary embodiment. BMS 11 is shown to include a plurality of BMS subsystems 20-26. Each BMS subsystem 20-26 is connected to a plurality of BMS devices and makes data points for varying connected devices available to upstream BMS controller 12. Additionally, BMS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BMS 11 may include a HVAC system 20. HVAC system 20 may control HVAC operations building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BMS 11). AHU 32 may serve variable air volume (VAV) boxes 38, 40 (named “VAV_3” and “VAV_4” in BMS 11). Likewise, AHU 34 may serve VAV boxes 36 and 110 (named “VAV_2” and “VAV_1”).

HVAC system 42 may also include chiller 30 (named “Chiller A” in BMS 11). Chiller 30 may provide chilled fluid to AHU 32 and/or to AHU 34. HVAC system 42 may receive data (i.e., BMS inputs such as temperature sensor readings, damper positions, temperature setpoints, etc.) from AHUs 32, 34. HVAC system 42 may provide such BMS inputs to HVAC system 20 and on to middleware 14 and BMS controller 12. Similarly, other BMS subsystems may receive inputs from other building devices or objects and provide the received inputs to BMS controller 12 (e.g., via middleware 14).

Middleware 14 may include services that allow interoperable communication to, from, or between disparate BMS subsystems 20-26 of BMS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BMS controller 12, middleware 14 and BMS controller 12 may integrated in some embodiments. For example, middleware 14 may be a part of BMS controller 12.

Still referring to FIG. 2, window control system 22 may receive shade control information from one or more shade controls, ambient light level information from one or more light sensors, and/or other BMS inputs (e.g., sensor information, setpoint information, current state information, etc.) from downstream devices. Window control system 22 may include window controllers 107, 108 (e.g., named “local window controller A” and “local window controller B,” respectively, in BMS 11). Window controllers 107, 108 control the operation of subsets of window control system 22. For example, window controller 108 may control window blind or shade operations for a given room, floor, or building in the BMS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BMS subsystems 20-26 may be connected to BMS controller 12 via middleware 14 and may be configured to provide BMS controller 12 with BMS inputs from various BMS subsystems 20-26 and their varying downstream devices. BMS controller 12 may be configured to make differences in building subsystems transparent at the human-machine interface or client interface level (e.g., for connected or hosted user interface (UI) clients 16, remote applications 18, etc.). BMS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

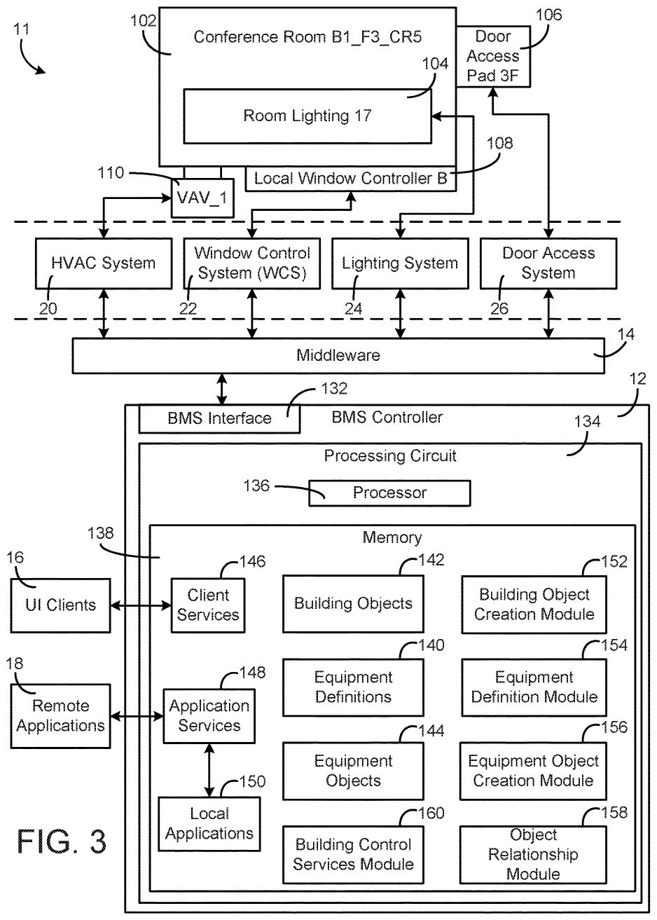

Referring now to FIG. 3, a block diagram illustrating a portion of BMS 11 in greater detail is shown, according to an exemplary embodiment. Particularly, FIG. 3 illustrates a portion of BMS 11 that services a conference room 102 of building 10 (named “B1_F3_CR5”). Conference room 102 may be affected by many different building devices connected to many different BMS subsystems. For example, conference room 102 includes or is otherwise affected by VAV box 110, window controller 108 (e.g., a blind controller), a system of lights 104 (named “Room Lighting 17”), and a door access pad 106.

Each of the building devices shown at the top of FIG. 3 may include local control circuitry configured to provide signals to their supervisory controllers or more generally to the BMS subsystems 20-26. The local control circuitry of the building devices shown at the top of FIG. 3 may also be configured to receive and respond to control signals, commands, setpoints, or other data from their supervisory controllers. For example, the local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. Room lighting 104 may include circuitry that affects the lighting in response to control signals received from a field controller that is part of lighting system 24. Access pad 106 may include circuitry that affects door access (e.g., locking or unlocking the door) in response to control signals received from a field controller that is part of door access system 26.

Still referring to FIG. 3, BMS controller 12 is shown to include a BMS interface 132 in communication with middleware 14. In some embodiments, BMS interface 132 is a communications interface. For example, BMS interface 132 may include wired or wireless interfaces (e.g., jacks, antennas, transmitters, receivers, transceivers, wire terminals, etc.) for conducting data communications with various systems, devices, or networks. BMS interface 132 can include an Ethernet card and port for sending and receiving data via an Ethernet-based communications network. In another example, BMS interface 132 includes a Wi-Fi transceiver for communicating via a wireless communications network. BMS interface 132 may be configured to communicate via local area networks or wide area networks (e.g., the Internet, a building WAN, etc.).

In some embodiments, BMS interface 132 and/or middleware 14 includes an application gateway configured to receive input from applications running on client devices. For example, BMS interface 132 and/or middleware 14 may include one or more wireless transceivers (e.g., a Wi-Fi transceiver, a Bluetooth transceiver, a NFC transceiver, a cellular transceiver, etc.) for communicating with client devices. BMS interface 132 may be configured to receive building management inputs from middleware 14 or directly from one or more BMS subsystems 20-26. BMS interface 132 and/or middleware 14 can include any number of software buffers, queues, listeners, filters, translators, or other communications-supporting services.

Still referring to FIG. 3, BMS controller 12 is shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.).

Memory 138 may include one or more devices (e.g., memory units, memory devices, storage devices, etc.) for storing data and/or computer code for completing and/or facilitating the various processes described in the present disclosure. Memory 138 may include random access memory (RAM), read-only memory (ROM), hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 may be communicably connected to processor 136 via processing circuit 134 and may include computer code for executing (e.g., by processor 136) one or more processes described herein. When processor 136 executes instructions stored in memory 138 for completing the various activities described herein, processor 136 generally configures BMS controller 12 (and more particularly processing circuit 134) to complete such activities.

Still referring to FIG. 3, memory 138 is shown to include building objects 142. In some embodiments, BMS controller 12 uses building objects 142 to group otherwise ungrouped or unassociated devices so that the group may be addressed or handled by applications together and in a consistent manner (e.g., a single user interface for controlling all of the BMS devices that affect a particular building zone or room). Building objects can apply to spaces of any granularity. For example, a building object can represent an entire building, a floor of a building, or individual rooms on each floor. In some embodiments, BMS controller 12 creates and/or stores a building object in memory 138 for each zone or room of building 10. Building objects 142 can be accessed by UI clients 16 and remote applications 18 to provide a comprehensive user interface for controlling and/or viewing information for a particular building zone. Building objects 142 may be created by building object creation module 152 and associated with equipment objects by object relationship module 158, described in greater detail below.

Still referring to FIG. 3, memory 138 is shown to include equipment definitions 140. Equipment definitions 140 stores the equipment definitions for various types of building equipment. Each equipment definition may apply to building equipment of a different type. For example, equipment definitions 140 may include different equipment definitions for variable air volume modular assemblies (VMAs), fan coil units, air handling units (AHUs), lighting fixtures, water pumps, and/or other types of building equipment.

Equipment definitions 140 define the types of data points that are generally associated with various types of building equipment. For example, an equipment definition for VMA may specify data point types such as room temperature, damper position, supply air flow, and/or other types data measured or used by the VMA. Equipment definitions 140 allow for the abstraction (e.g., generalization, normalization, broadening, etc.) of equipment data from a specific BMS device so that the equipment data can be applied to a room or space.

Each of equipment definitions 140 may include one or more point definitions. Each point definition may define a data point of a particular type and may include search criteria for automatically discovering and/or identifying data points that satisfy the point definition. An equipment definition can be applied to multiple pieces of building equipment of the same general type (e.g., multiple different VMA controllers). When an equipment definition is applied to a BMS device, the search criteria specified by the point definitions can be used to automatically identify data points provided by the BMS device that satisfy each point definition.

In some embodiments, equipment definitions 140 define data point types as generalized types of data without regard to the model, manufacturer, vendor, or other differences between building equipment of the same general type. The generalized data points defined by equipment definitions 140 allows each equipment definition to be referenced by or applied to multiple different variants of the same type of building equipment.

In some embodiments, equipment definitions 140 facilitate the presentation of data points in a consistent and user-friendly manner. For example, each equipment definition may define one or more data points that are displayed via a user interface. The displayed data points may be a subset of the data points defined by the equipment definition.

In some embodiments, equipment definitions 140 specify a system type (e.g., HVAC, lighting, security, fire, etc.), a system sub-type (e.g., terminal units, air handlers, central plants), and/or data category (e.g., critical, diagnostic, operational) associated with the building equipment defined by each equipment definition. Specifying such attributes of building equipment at the equipment definition level allows the attributes to be applied to the building equipment along with the equipment definition when the building equipment is initially defined. Building equipment can be filtered by various attributes provided in the equipment definition to facilitate the reporting and management of equipment data from multiple building systems.

Equipment definitions 140 can be automatically created by abstracting the data points provided by archetypal controllers (e.g., typical or representative controllers) for various types of building equipment. In some embodiments, equipment definitions 140 are created by equipment definition module 154, described in greater detail below.

Still referring to FIG. 3, memory 138 is shown to include equipment objects 144. Equipment objects 144 may be software objects that define a mapping between a data point type (e.g., supply air temperature, room temperature, damper position) and an actual data point (e.g., a measured or calculated value for the corresponding data point type) for various pieces of building equipment. Equipment objects 144 may facilitate the presentation of equipment-specific data points in an intuitive and user-friendly manner by associating each data point with an attribute identifying the corresponding data point type. The mapping provided by equipment objects 144 may be used to associate a particular data value measured or calculated by BMS 11 with an attribute that can be displayed via a user interface.

Equipment objects 144 can be created (e.g., by equipment object creation module 156) by referencing equipment definitions 140. For example, an equipment object can be created by applying an equipment definition to the data points provided by a BMS device. The search criteria included in an equipment definition can be used to identify data points of the building equipment that satisfy the point definitions. A data point that satisfies a point definition can be mapped to an attribute of the equipment object corresponding to the point definition.

Each equipment object may include one or more attributes defined by the point definitions of the equipment definition used to create the equipment object. For example, an equipment definition which defines the attributes “Occupied Command,” “Room Temperature,” and “Damper Position” may result in an equipment object being created with the same attributes. The search criteria provided by the equipment definition are used to identify and map data points associated with a particular BMS device to the attributes of the equipment object. The creation of equipment objects is described in greater detail below with reference to equipment object creation module 156.

Equipment objects 144 may be related with each other and/or with building objects 142. Causal relationships can be established between equipment objects to link equipment objects to each other. For example, a causal relationship can be established between a VMA and an AHU which provides airflow to the VMA. Causal relationships can also be established between equipment objects 144 and building objects 142. For example, equipment objects 144 can be associated with building objects 142 representing particular rooms or zones to indicate that the equipment object serves that room or zone. Relationships between objects are described in greater detail below with reference to object relationship module 158.

Still referring to FIG. 3, memory 138 is shown to include client services 146 and application services 148. Client services 146 may be configured to facilitate interaction and/or communication between BMS controller 12 and various internal or external clients or applications. For example, client services 146 may include web services or application programming interfaces available for communication by UI clients 16 and remote applications 18 (e.g., applications running on a mobile device, energy monitoring applications, applications allowing a user to monitor the performance of the BMS, automated fault detection and diagnostics systems, etc.). Application services 148 may facilitate direct or indirect communications between remote applications 18, local applications 150, and BMS controller 12. For example, application services 148 may allow BMS controller 12 to communicate (e.g., over a communications network) with remote applications 18 running on mobile devices and/or with other BMS controllers.

In some embodiments, application services 148 facilitate an applications gateway for conducting electronic data communications with UI clients 16 and/or remote applications 18.

For example, application services 148 may be configured to receive communications from mobile devices and/or BMS devices. Client services 146 may provide client devices with a graphical user interface that consumes data points and/or display data defined by equipment definitions 140 and mapped by equipment objects 144.

Still referring to FIG. 3, memory 138 is shown to include a building object creation module 152. Building object creation module 152 may be configured to create the building objects stored in building objects 142. Building object creation module 152 may create a software building object for various spaces within building 10. Building object creation module 152 can create a building object for a space of any size or granularity. For example, building object creation module 152 can create a building object representing an entire building, a floor of a building, or individual rooms on each floor. In some embodiments, building object creation module 152 creates and/or stores a building object in memory 138 for each zone or room of building 10.

The building objects created by building object creation module 152 can be accessed by UI clients 16 and remote applications 18 to provide a comprehensive user interface for controlling and/or viewing information for a particular building zone. Building objects 142 can group otherwise ungrouped or unassociated devices so that the group may be addressed or handled by applications together and in a consistent manner (e.g., a single user interface for controlling all of the BMS devices that affect a particular building zone or room). In some embodiments, building object creation module 152 uses the systems and methods described in U.S. patent application Ser. No. 12/887,390, filed Sep. 21, 2010, for creating software defined building objects.

In some embodiments, building object creation module 152 provides a user interface for guiding a user through a process of creating building objects. For example, building object creation module 152 may provide a user interface to client devices (e.g., via client services 146) that allows a new space to be defined. In some embodiments, building object creation module 152 defines spaces hierarchically. For example, the user interface for creating building objects may prompt a user to create a space for a building, for floors within the building, and/or for rooms or zones within each floor.

In some embodiments, building object creation module 152 creates building objects automatically or semi-automatically. For example, building object creation module 152 may automatically define and create building objects using data imported from another data source (e.g., user view folders, a table, a spreadsheet, etc.). In some embodiments, building object creation module 152 references an existing hierarchy for BMS 11 to define the spaces within building 10. For example, BMS 11 may provide a listing of controllers for building 10 (e.g., as part of a network of data points) that have the physical location (e.g., room name) of the controller in the name of the controller itself. Building object creation module 152 may extract room names from the names of BMS controllers defined in the network of data points and create building objects for each extracted room. Building objects may be stored in building objects 142.

Still referring to FIG. 3, memory 138 is shown to include an equipment definition module 154. Equipment definition module 154 may be configured to create equipment definitions for various types of building equipment and to store the equipment definitions in equipment definitions 140. In some embodiments, equipment definition module 154 creates equipment definitions by abstracting the data points provided by archetypal controllers (e.g., typical or representative controllers) for various types of building equipment. For example, equipment definition module 154 may receive a user selection of an archetypal controller via a user interface. The archetypal controller may be specified as a user input or selected automatically by equipment definition module 154. In some embodiments, equipment definition module 154 selects an archetypal controller for building equipment associated with a terminal unit such as a VMA.

Equipment definition module 154 may identify one or more data points associated with the archetypal controller. Identifying one or more data points associated with the archetypal controller may include accessing a network of data points provided by BMS 11. The network of data points may be a hierarchical representation of data points that are measured, calculated, or otherwise obtained by various BMS devices. BMS devices may be represented in the network of data points as nodes of the hierarchical representation with associated data points depending from each BMS device. Equipment definition module 154 may find the node corresponding to the archetypal controller in the network of data points and identify one or more data points which depend from the archetypal controller node.

Equipment definition module 154 may generate a point definition for each identified data point of the archetypal controller. Each point definition may include an abstraction of the corresponding data point that is applicable to multiple different controllers for the same type of building equipment. For example, an archetypal controller for a particular VMA (i.e., “VMA-20”) may be associated an equipment-specific data point such as “VMA-20.DPR-POS” (i.e., the damper position of VMA-20) and/or “VMA-20.SUP-FLOW” (i.e., the supply air flow rate through VMA-20). Equipment definition module 154 abstract the equipment-specific data points to generate abstracted data point types that are generally applicable to other equipment of the same type. For example, equipment definition module 154 may abstract the equipment-specific data point “VMA-20.DPR-POS” to generate the abstracted data point type “DPR-POS” and may abstract the equipment-specific data point “VMA-20.SUP-FLOW” to generate the abstracted data point type “SUP-FLOW.” Advantageously, the abstracted data point types generated by equipment definition module 154 can be applied to multiple different variants of the same type of building equipment (e.g., VMAs from different manufacturers, VMAs having different models or output data formats, etc.).

In some embodiments, equipment definition module 154 generates a user-friendly label for each point definition. The user-friendly label may be a plain text description of the variable defined by the point definition. For example, equipment definition module 154 may generate the label “Supply Air Flow” for the point definition corresponding to the abstracted data point type “SUP-FLOW” to indicate that the data point represents a supply air flow rate through the VMA. The labels generated by equipment definition module 154 may be displayed in conjunction with data values from BMS devices as part of a user-friendly interface.

In some embodiments, equipment definition module 154 generates search criteria for each point definition. The search criteria may include one or more parameters for identifying another data point (e.g., a data point associated with another controller of BMS 11 for the same type of building equipment) that represents the same variable as the point definition. Search criteria may include, for example, an instance number of the data point, a network address of the data point, and/or a network point type of the data point.

In some embodiments, search criteria include a text string abstracted from a data point associated with the archetypal controller. For example, equipment definition module 154 may generate the abstracted text string “SUP-FLOW” from the equipment-specific data point “VMA-20.SUP-FLOW.” Advantageously, the abstracted text string matches other equipment-specific data points corresponding to the supply air flow rates of other BMS devices (e.g., “VMA-18.SUP-FLOW,” “SUP-FLOW.VMA-01,” etc.). Equipment definition module 154 may store a name, label, and/or search criteria for each point definition in memory 138.

Equipment definition module 154 may use the generated point definitions to create an equipment definition for a particular type of building equipment (e.g., the same type of building equipment associated with the archetypal controller). The equipment definition may include one or more of the generated point definitions. Each point definition defines a potential attribute of BMS devices of the particular type and provides search criteria for identifying the attribute among other data points provided by such BMS devices.

In some embodiments, the equipment definition created by equipment definition module 154 includes an indication of display data for BMS devices that reference the equipment definition. Display data may define one or more data points of the BMS device that will be displayed via a user interface. In some embodiments, display data are user defined. For example, equipment definition module 154 may prompt a user to select one or more of the point definitions included in the equipment definition to be represented in the display data. Display data may include the user-friendly label (e.g., “Damper Position”) and/or short name (e.g., “DPR-POS”) associated with the selected point definitions.

In some embodiments, equipment definition module 154 provides a visualization of the equipment definition via a graphical user interface. The visualization of the equipment definition may include a point definition portion which displays the generated point definitions, a user input portion configured to receive a user selection of one or more of the point definitions displayed in the point definition portion, and/or a display data portion which includes an indication of an abstracted data point corresponding to each of the point definitions selected via the user input portion. The visualization of the equipment definition can be used to add, remove, or change point definitions and/or display data associated with the equipment definitions.

Equipment definition module 154 may generate an equipment definition for each different type of building equipment in BMS 11 (e.g., VMAs, chillers, AHUs, etc.). Equipment definition module 154 may store the equipment definitions in a data storage device (e.g., memory 138, equipment definitions 140, an external or remote data storage device, etc.).

Still referring to FIG. 3, memory 138 is shown to include an equipment object creation module 156. Equipment object creation module 156 may be configured to create equipment objects for various BMS devices. In some embodiments, equipment object creation module 156 creates an equipment object by applying an equipment definition to the data points provided by a BMS device. For example, equipment object creation module 156 may receive an equipment definition created by equipment definition module 154. Receiving an equipment definition may include loading or retrieving the equipment definition from a data storage device.

In some embodiments, equipment object creation module 156 determines which of a plurality of equipment definitions to retrieve based on the type of BMS device used to create the equipment object. For example, if the BMS device is a VMA, equipment object creation module 156 may retrieve the equipment definition for VMAs; whereas if the BMS device is a chiller, equipment object creation module 156 may retrieve the equipment definition for chillers. The type of BMS device to which an equipment definition applies may be stored as an attribute of the equipment definition. Equipment object creation module 156 may identify the type of BMS device being used to create the equipment object and retrieve the corresponding equipment definition from the data storage device.

In other embodiments, equipment object creation module 156 receives an equipment definition prior to selecting a BMS device. Equipment object creation module 156 may identify a BMS device of BMS 11 to which the equipment definition applies. For example, equipment object creation module 156 may identify a BMS device that is of the same type of building equipment as the archetypal BMS device used to generate the equipment definition. In various embodiments, the BMS device used to generate the equipment object may be selected automatically (e.g., by equipment object creation module 156), manually (e.g., by a user) or semi-automatically (e.g., by a user in response to an automated prompt from equipment object creation module 156).

In some embodiments, equipment object creation module 156 creates an equipment discovery table based on the equipment definition. For example, equipment object creation module 156 may create an equipment discovery table having attributes (e.g., columns) corresponding to the variables defined by the equipment definition (e.g., a damper position attribute, a supply air flow rate attribute, etc.). Each column of the equipment discovery table may correspond to a point definition of the equipment definition. The equipment discovery table may have columns that are categorically defined (e.g., representing defined variables) but not yet mapped to any particular data points.

Equipment object creation module 156 may use the equipment definition to automatically identify one or more data points of the selected BMS device to map to the columns of the equipment discovery table. Equipment object creation module 156 may search for data points of the BMS device that satisfy one or more of the point definitions included in the equipment definition. In some embodiments, equipment object creation module 156 extracts a search criterion from each point definition of the equipment definition. Equipment object creation module 156 may access a data point network of the building automation system to identify one or more data points associated with the selected BMS device. Equipment object creation module 156 may use the extracted search criterion to determine which of the identified data points satisfy one or more of the point definitions.

In some embodiments, equipment object creation module 156 automatically maps (e.g., links, associates, relates, etc.) the identified data points of selected BMS device to the equipment discovery table. A data point of the selected BMS device may be mapped to a column of the equipment discovery table in response to a determination by equipment object creation module 156 that the data point satisfies the point definition (e.g., the search criteria) used to generate the column. For example, if a data point of the selected BMS device has the name “VMA-18.SUP-FLOW” and a search criterion is the text string “SUP-FLOW,” equipment object creation module 156 may determine that the search criterion is met. Accordingly, equipment object creation module 156 may map the data point of the selected BMS device to the corresponding column of the equipment discovery table.

Advantageously, equipment object creation module 156 may create multiple equipment objects and map data points to attributes of the created equipment objects in an automated fashion (e.g., without human intervention, with minimal human intervention, etc.). The search criteria provided by the equipment definition facilitates the automatic discovery and identification of data points for a plurality of equipment object attributes. Equipment object creation module 156 may label each attribute of the created equipment objects with a device-independent label derived from the equipment definition used to create the equipment object. The equipment objects created by equipment object creation module 156 can be viewed (e.g., via a user interface) and/or interpreted by data consumers in a consistent and intuitive manner regardless of device-specific differences between BMS devices of the same general type. The equipment objects created by equipment object creation module 156 may be stored in equipment objects 144.

Still referring to FIG. 3, memory 138 is shown to include an object relationship module 158. Object relationship module 158 may be configured to establish relationships between equipment objects 144. In some embodiments, object relationship module 158 establishes causal relationships between equipment objects 144 based on the ability of one BMS device to affect another BMS device. For example, object relationship module 158 may establish a causal relationship between a terminal unit (e.g., a VMA) and an upstream unit (e.g., an AHU, a chiller, etc.) which affects an input provided to the terminal unit (e.g., air flow rate, air temperature, etc.).

Object relationship module 158 may establish relationships between equipment objects 144 and building objects 142 (e.g., spaces). For example, object relationship module 158 may associate equipment objects 144 with building objects 142 representing particular rooms or zones to indicate that the equipment object serves that room or zone. In some embodiments, object relationship module 158 provides a user interface through which a user can define relationships between equipment objects 144 and building objects 142. For example, a user can assign relationships in a “drag and drop” fashion by dragging and dropping a building object and/or an equipment object into a “serving” cell of an equipment object provided via the user interface to indicate that the BMS device represented by the equipment object serves a particular space or BMS device.

Still referring to FIG. 3, memory 138 is shown to include a building control services module 160. Building control services module 160 may be configured to automatically control BMS 11 and the various subsystems thereof. Building control services module 160 may utilize closed loop control, feedback control, PI control, model predictive control, or any other type of automated building control methodology to control the environment (e.g., a variable state or condition) within building 10.

Building control services module 160 may receive inputs from sensory devices (e.g., temperature sensors, pressure sensors, flow rate sensors, humidity sensors, electric current sensors, cameras, radio frequency sensors, microphones, etc.), user input devices (e.g., computer terminals, client devices, user devices, etc.) or other data input devices via BMS interface 132. Building control services module 160 may apply the various inputs to a building energy use model and/or a control algorithm to determine an output for one or more building control devices (e.g., dampers, air handling units, chillers, boilers, fans, pumps, etc.) in order to affect a variable state or condition within building 10 (e.g., zone temperature, humidity, air flow rate, etc.).

In some embodiments, building control services module 160 is configured to control the environment of building 10 on a zone-individualized level. For example, building control services module 160 may control the environment of two or more different building zones using different setpoints, different constraints, different control methodology, and/or different control parameters. Building control services module 160 may operate BMS 11 to maintain building conditions (e.g., temperature, humidity, air quality, etc.) within a setpoint range, to optimize energy performance (e.g., to minimize energy consumption, to minimize energy cost, etc.), and/or to satisfy any constraint or combination of constraints as may be desirable for various implementations.

In some embodiments, building control services module 160 uses the location of various BMS devices to translate an input received from a building system into an output or control signal for the building system. Building control services module 160 may receive location information for BMS devices and automatically set or recommend control parameters for the BMS devices based on the locations of the BMS devices. For example, building control services module 160 may automatically set a flow rate setpoint for a VAV box based on the size of the building zone in which the VAV box is located.

Building control services module 160 may determine which of a plurality of sensors to use in conjunction with a feedback control loop based on the locations of the sensors within building 10. For example, building control services module 160 may use a signal from a temperature sensor located in a building zone as a feedback signal for controlling the temperature of the building zone in which the temperature sensor is located.

In some embodiments, building control services module 160 automatically generates control algorithms for a controller or a building zone based on the location of the zone in the building 10. For example, building control services module 160 may be configured to predict a change in demand resulting from sunlight entering through windows based on the orientation of the building and the locations of the building zones (e.g., east-facing, west-facing, perimeter zones, interior zones, etc.).

Building control services module 160 may use zone location information and interactions between adjacent building zones (rather than considering each zone as an isolated system) to more efficiently control the temperature and/or airflow within building 10. For control loops that are conducted at a larger scale (i.e., floor level) building control services module 160 may use the location of each building zone and/or BMS device to coordinate control functionality between building zones. For example, building control services module 160 may consider heat exchange and/or air exchange between adjacent building zones as a factor in determining an output control signal for the building zones.

In some embodiments, building control services module 160 is configured to optimize the energy efficiency of building 10 using the locations of various BMS devices and the control parameters associated therewith. Building control services module 160 may be configured to achieve control setpoints using building equipment with a relatively lower energy cost (e.g., by causing airflow between connected building zones) in order to reduce the loading on building equipment with a relatively higher energy cost (e.g., chillers and roof top units). For example, building control services module 160 may be configured to move warmer air from higher elevation zones to lower elevation zones by establishing pressure gradients between connected building zones.

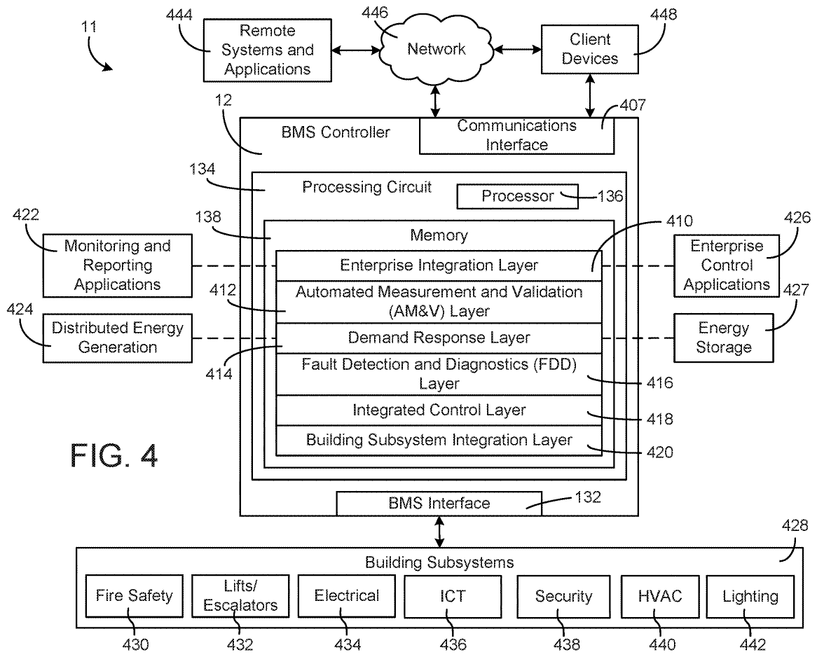

Referring now to FIG. 4, another block diagram illustrating a portion of BMS 11 in greater detail is shown, according to some embodiments. BMS 11 can be implemented in building 10 to automatically monitor and control various building functions. BMS 11 is shown to include BMS controller 12 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10.

Each of building subsystems 428 can include any number of devices, controllers, and connections for completing its individual functions and control activities. HVAC subsystem 440 can include many of the same components as HVAC system 20, as described with reference to FIGS. 2-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 12 is shown to include a communications interface 407 and a BMS interface 132. Interface 407 may facilitate communications between BMS controller 12 and external applications (e.g., monitoring and reporting applications 422, enterprise control applications 426, remote systems and applications 444, applications residing on client devices 448, etc.) for allowing user control, monitoring, and adjustment to BMS controller 12 and/or subsystems 428. Interface 407 may also facilitate communications between BMS controller 12 and client devices 448. BMS interface 132 may facilitate communications between BMS controller 12 and building subsystems 428 (e.g., HVAC, lighting security, lifts, power distribution, business, etc.).

Interfaces 407, 132 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 132 can be direct (e.g., local wired or wireless communications) or via a communications network 446 (e.g., a WAN, the Internet, a cellular network, etc.). For example, interfaces 407, 132 can include an Ethernet card and port for sending and receiving data via an Ethernet-based communications link or network. In another example, interfaces 407, 132 can include a Wi-Fi transceiver for communicating via a wireless communications network. In another example, one or both of interfaces 407, 132 can include cellular or mobile phone communications transceivers. In one embodiment, communications interface 407 is a power line communications interface and BMS interface 132 is an Ethernet interface. In other embodiments, both communications interface 407 and BMS interface 132 are Ethernet interfaces or are the same Ethernet interface.

Still referring to FIG. 4, BMS controller 12 is shown to include a processing circuit 134 including a processor 136 and memory 138. Processing circuit 134 can be communicably connected to BMS interface 132 and/or communications interface 407 such that processing circuit 134 and the various components thereof can send and receive data via interfaces 407, 132. Processor 136 can be implemented as a general purpose processor, an application specific integrated circuit (ASIC), one or more field programmable gate arrays (FPGAs), a group of processing components, or other suitable electronic processing components.

Memory 138 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 138 can be or include volatile memory or non-volatile memory. Memory 138 can include database components, object code components, script components, or any other type of information structure for supporting the various activities and information structures described in the present application. According to some embodiments, memory 138 is communicably connected to processor 136 via processing circuit 134 and includes computer code for executing (e.g., by processing circuit 134 and/or processor 136) one or more processes described herein.

In some embodiments, BMS controller 12 is implemented within a single computer (e.g., one server, one housing, etc.). In various other embodiments BMS controller 12 can be distributed across multiple servers or computers (e.g., that can exist in distributed locations).

Further, while FIG. 4 shows applications 422 and 426 as existing outside of BMS controller 12, in some embodiments, applications 422 and 426 can be hosted within BMS controller 12 (e.g., within memory 138).

Still referring to FIG. 4, memory 138 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 11.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 12. In yet other embodiments, enterprise control applications 426 can work with layers 410-420 to optimize building performance (e.g., efficiency, energy use, comfort, or safety) based on inputs received at interface 407 and/or BMS interface 132.

Building subsystem integration layer 420 can be configured to manage communications between BMS controller 12 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427, or from other sources.

Demand response layer 414 may receive inputs from other layers of BMS controller 12 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner.

Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 11 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint.

These processes can be examined by FDD layer 416 to expose when the system begins to degrade in performance and alert a user to repair the fault before it becomes more severe.

### High Availability Building Management With Redundant Building Management Servers

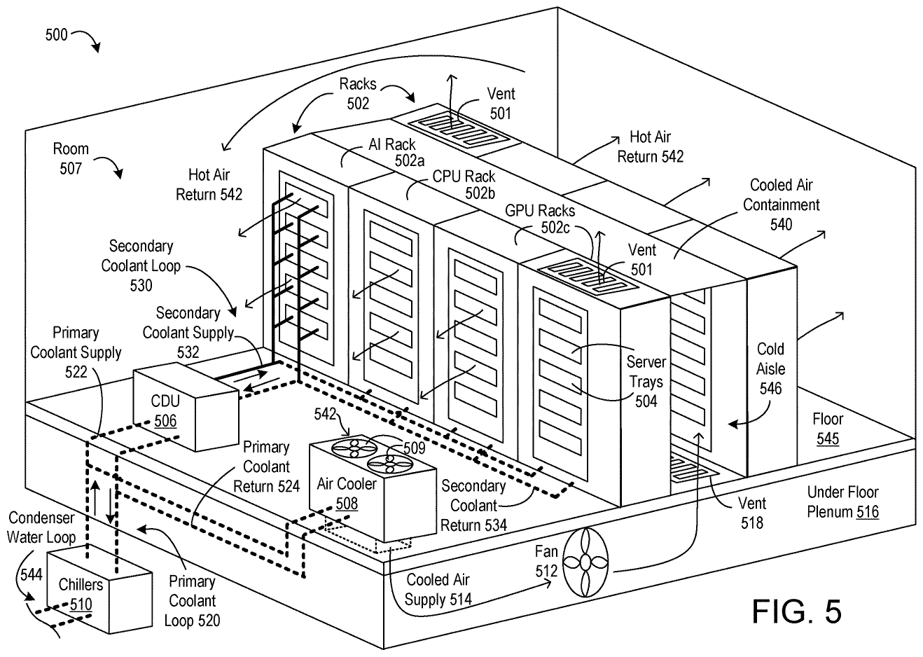

Referring now to FIG. 5, a building management system 510 is shown to include a plurality of servers 512 (e.g., building management servers, building management controllers, etc.), one or more client devices 514, and a plurality of building subsystems 516. The plurality of building subsystems 516 may be the same as, or similar to the building subsystems 428, described in reference to FIG. 4. The plurality of building subsystems 516 is shown to include a fire safety subsystem 518, a lift and/or escalator subsystem 520, a building electrical subsystem 522, an information communication technology (ICT) subsystem 524, a security subsystem 526, an HVAC subsystem 528, and a lighting subsystem 530. In various embodiments, the plurality of building subsystems 516 can include fewer, additional, or alternative building subsystems. For example, the plurality of building subsystems 516 can include an information technology (IT) or computing subsystem having servers, server racks, battery backup devices, power distribution devices, coolant distribution units, and/or any other IT or computing equipment commonly used in data centers. One example of a data center with IT equipment which can be included in the plurality of building subsystems 516 is described in detail in U.S. Provisional Patent Application No. 63/818,920 filed Jun. 6, 2025, the entire disclosure of which is incorporated by reference herein.

Each client device of the one or more client devices 514 can be a middleware device (e.g., a supervisory controller, a supervisory control module, a programmable logic controller, etc.) communicably coupled with one or more of the plurality of building subsystems 516 (e.g., via one or more ethernet, serial, or discrete input and output (I/O) interface). The one or more client devices 514, together or individually, may be the same as, or similar to, the middleware 14, described in reference to FIGS. 2 and 3. Each client device of the one or more client devices 514 can be any type of device that can be instructed to carry out sequences of arithmetic or logical operations contained in a program. Each client device of the one or more client devices 514 may be any controller or computing device previously described (e.g., the middleware 14). Each client device of the one or more client devices 514 can be an on-site computing device (e.g., a computing device located within the building 10), or each client device of the one or more client devices 514 may be implemented as a cloud or distributed computing device (e.g., a computing device located at a site outside of the building 10, a computing device distributed across multiple locations, etc.).

Each server of the plurality of servers 512 can be communicably coupled with the other servers of the plurality of servers 512 and each client device of the one or more client devices 514 (e.g., via an ethernet interface, a local area network, a wide area network, the Internet, etc.). Each server of the plurality of servers 512 may be the same as, or similar to, the BMS controller 12, described in reference to FIGS. 2-4. Each server of the plurality of servers can be any type of device that can be instructed to carry out sequences of arithmetic or logical operations contained in a program. Each server of the plurality of servers 512 may be any controller or computing device previously described (e.g., the BMS controller 12). Each server of the plurality of servers can be an on-site computing device (e.g., a computing device located within the building 10), or each server of the plurality of servers 512 may be implemented as a cloud or distributed computing device (e.g., a computing device located at a site outside of the building 10, a computing device distributed across multiple locations, etc.).

The building management system 510 can additionally include one or more databases 532 operably coupled with each server of the plurality of servers 512 such that each server of the plurality of servers 512 can store data to and retrieve data from the one or more databases 532.

The one or more databases 532 may be accessed by the plurality of servers 512. In some embodiments, the one or more databases 532 are provided by a data server or data servers separate from each server of the plurality of servers 512 but communicably coupled with each server of the plurality of servers 512. In some embodiments, the one or more databases 532 are provided by the plurality of servers 512 themselves. The one or more databases 532 may be SQL or SQL High Availability databases.

The building management system 510 can additionally include one or more user devices 534 (e.g., a terminal, a computer, a laptop computer, a tablet, a smartphone, etc.) communicably coupled with each server of the plurality of servers 512 such that the one or more user devices 534 can send data to, and receive data from, each server of the plurality of servers 512. The one or more user devices 534 may further be communicably coupled with each client device of the one or more client devices 514 such that the one or more user devices 534 can send data to and receive data from each of the one or more client devices 514. In some embodiments, each server of the plurality of servers 512 and/or each client device of the one or more client devices is configured to provide a user interface on the one or more user devices 534.

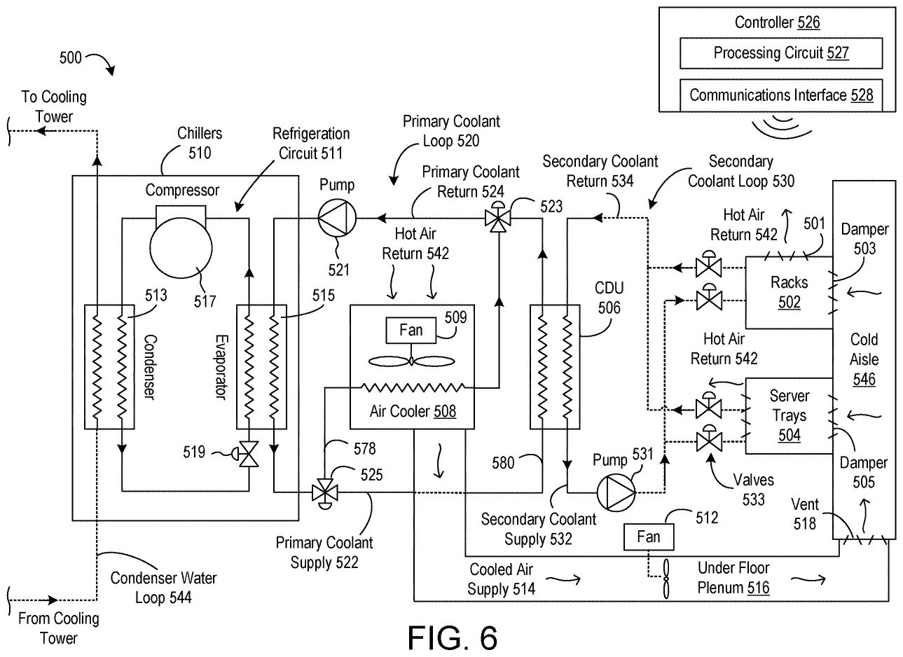

Referring now to FIG. 6, each client device of the one or more client devices 514 can perform supervisory and/or control functions (e.g., control scheduling, alarm and event management, energy management, data exchange, historical data storage and management, and custom control, etc.) in relation to the one or more building subsystems of the plurality of building subsystems 516 communicably coupled thereto. Each client device of the one or more client devices 514 can further allow interoperable communication to, from, or between the plurality of building subsystems 516. As shown in FIG. 6, the one or more client devices 514 includes a first client device 514a, a second client device 514b, a third client device 514c, and an nth client device 514n. It should be understood, however, that the building management system 510 can include any number of client devices based on the building management needs, and the number of building management subsystems included in the building 10.

The plurality of servers 512 can perform site-wide director and/or data repository functions for the building management system 510. A first server of the plurality of servers 512 may be configured as a primary server. The primary server can provide a plurality of building management services (e.g., historical data collection, site-wide control, custom or scheduled reporting, site-wide alarm and event management, user interfacing, etc.) for the one or more client devices 514, the one or more databases 532, and the one or more user devices 534. A second server of the plurality of servers 512 may be configured as a redundant, or secondary server. The secondary server can provide redundant instances of the plurality of building management services while suppressing one or more outputs of the redundant instances of the plurality of building management services that may result in discordant or undesirable behavior if repeated. For example, the secondary server may suppress the transmission of alarms and/or notifications to systems external to the building management system 510, the generation of scheduled reports, and/or the automatic configuration of client devices. The secondary server can monitor the status of the primary server and, upon determining the primary server is inactive, unavailable, or otherwise offline, unsuppress the one or more outputs of the redundant instances of the plurality of building management services.

In some embodiments, the building management system 510 includes more than two servers to provide greater system redundancy (e.g., in the event that the primary server and the secondary server both fail). The additional servers can be configured precedentially. For example, a third server of the plurality of servers 512 can be configured as a second redundant server, or a tertiary server. The tertiary server can provide second redundant instances of the plurality of building management services while suppressing the one or more outputs of the redundant instances of the plurality of building management services. The tertiary server may monitor the status of both the primary server and the secondary server and, upon determining that both the primary server and the secondary server are inactive, unavailable, or otherwise offline, unsuppress the one or more outputs of the second redundant instances of the plurality of building management services.

As shown in FIG. 6, the plurality of servers 512 includes a first server 512a, a second server 512b, a third server 512c, and an nth server 512n. It should be understood, however, that the building management system 510 can include any number of servers greater than two to achieve a desirable degree of system redundancy. Each client device of the one or more client devices 514 can be configured to transmit any service requests and data transmissions to each server of the plurality of servers 512. Each server of the plurality of servers 512 can be configured to provide a user interface (e.g., on the one or more user devices 534). Each server of the plurality of servers 512 can be configured to access a shared database (e.g., a historical record) of operational data related to the plurality of building subsystems 516 (e.g., in the one or more databases 532). Each server of the plurality of servers 512 can share configuration changes with the other servers of the plurality of servers 512.

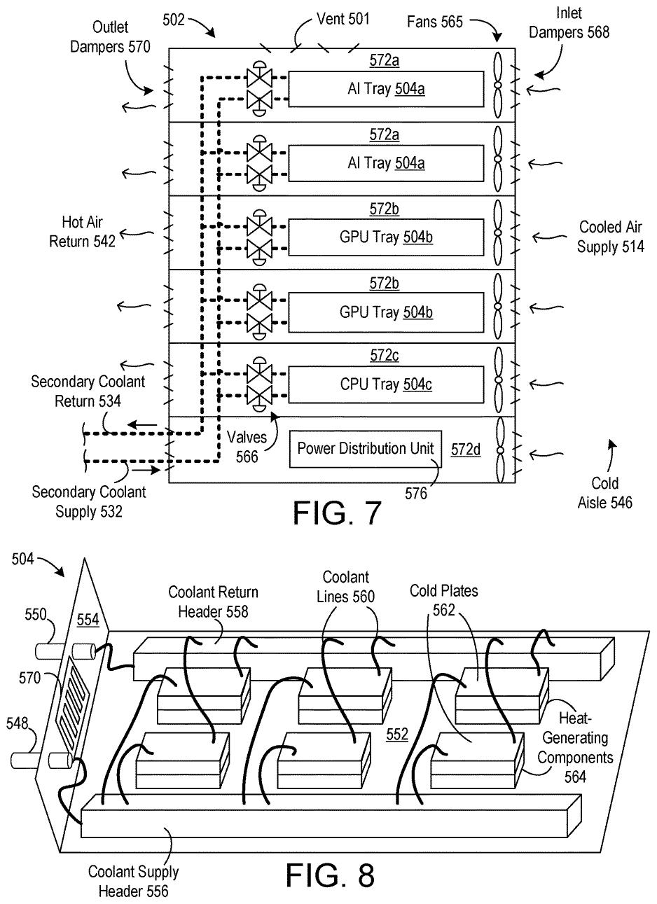

Referring now to FIG. 7, each client device of the one or more client devices 514 can include a processing circuit 712, a first communications interface 714, and a second communications interface 716. The first communications interface 714 and the second communications interface 716 can include wired or wireless interfaces (e.g., jacks, antennas, transmitters, receivers, transceivers, wire terminals, etc.) for conducting data or signal communication with various systems, devices, or networks. For example, the first communications interface 714 and the second communications interface 716 may include ethernet cards and ports for sending and receiving data via Ethernet-based communication networks (e.g., the Internet, a building WAN, a LAN, etc.) and may use a variety of communications protocols (e.g., BACnet, IP, Lon, etc.).

In some embodiments, the first communications interface 714 and the second communications interface 716 are differently configured. For example, the first communications interface 714 may include a discrete I/O interface for sending control signals to various controlled components (e.g., a controlled component of a building subsystem of the plurality of building subsystems 516) and receiving sensor data related to the actuation of the controlled components. The second communications interface 716 may include an ethernet card and port for conducting Ethernet-based communications with the plurality of servers 512. Each client device of the one or more client devices 514 can be communicably coupled with one or more building subsystems of the plurality of building subsystems 516 by its first communications interface 714. Each client device of the one or more client devices 514 can be communicably coupled with each server of the plurality of servers 512 by its second communications interface 716.

The processing circuit 712 may include one or more processors 718 and a memory 720. The one or more processors 718 can be implemented as one or more general purpose processors, one or more application specific integrated circuits (ASICs), one or more field programmable gate array (FPGAs), a group of processing components, or other suitable electronic processing components. The memory 720 (e.g., memory, memory unit, storage device, etc.) can include one or more devices (e.g., RAM, ROM, flash memory, hard disk storage, etc.) for storing data and/or computer code for completing or facilitating the various processes, layers, and modules described in the present disclosure. The memory 720 can be or include volatile memory or non-volatile memory. The memory 720 can include database components, object code components, script components, or any other type of information structure for supporting the various activities and information structures described in the present disclosure. According to some embodiments, memory 720 is communicably coupled to the one or more processors 718 via the processing circuit 712 and includes computer code for executing (e.g., by the processing circuit 712 or the one or more processors 718) one or more processes described herein.

The memory 720 is shown to include a supervisor 722, a controller 724, and a communications manager 726. The supervisor 722 may operate to obtain (e.g., measure, receive, acquire, etc.) operational data (e.g., time series data associated with a building subsystem, event data related to the operation or maintenance of the building subsystem, etc.) from the one or more building subsystems of the plurality of building subsystems 516 communicably coupled with the first communications interface 714. The supervisor 722 may transmit acquired operational data to each server of the plurality of servers 512 for archival (e.g., in the one or more databases 532) and/or analysis. The supervisor 722 may monitor the acquired operational data for threshold conditions and produce alarms or other notifications based on the occurrence of a threshold condition. The supervisor 722 may transmit operational data acquired from one building subsystem of the plurality of building subsystems 516 to another building subsystem of the plurality of building subsystems 516. For example, operational data such as computing load or power consumption as measured at an IT/computing subsystem (e.g., in a data center or other type of IT system) may be transmitted to the building electrical subsystem 522 for use in load balancing, power distribution, and/or demand planning. Several examples of how computing load data and/or power consumption data can communicated in the context of a data center are described in detail in U.S. Provisional Patent Application No. 63/819,397 filed Jun. 6, 2025, and U.S. Provisional Patent Application No. 63/818,925 filed Jun. 6, 2025 the entire disclosures of which are incorporated by reference herein.

The controller 724 may operate to alter the manner in which one or more of the plurality of building subsystems 516 is operating. The controller 724 can perform control scheduling of one or more building subsystems of the plurality of building subsystems 516. For example, a client device of the one or more client devices 514 may allow a user to define a schedule of when lighting should be provided in a building space. In accordance with the user defined schedule, the controller 724 of the client device can send control signals to the lighting subsystem 530 to turn on or off lights within the building space at times defined by the schedule. In some embodiments, the controller 724 may receive the user defined schedule from one server of the plurality of servers 512.

In some embodiments, the controller 724 directs the routine operation of one or more building subsystems of the plurality of building subsystems 516 (e.g., receives sensor data related to the building subsystems, implements control methods and/or processes, and transmits control signals to directly manage, regulate, and/or direct the operation of the one or more building subsystems). In some embodiments, the controller 724 indirectly controls the operation of one or more building subsystems of the plurality of building subsystems 516 (e.g., transmits set points or control commands to a controller or controllers of the one or more building subsystems to alter the manner in which the one or more building subsystems are operating).

The communications manager 726 may operate to coordinate communications with the plurality of servers 512. Each server of the plurality of servers 512 can provide various building management services, as will be described in greater detail in reference to FIG. 8 below. The communications manager 726 may transmit any service requests for the various building management services to each server of the plurality of servers 512. The communications manager 726 may also be configured to receive data (e.g., control commands, schedule data, requests for operating data, time sync data, etc.) from each server of the plurality of servers 512. The communications manager 726 may also be configured to transmit data (e.g., operational data related to a building subsystem of the plurality of building subsystems 516, time-series operational data, audit data, maintenance data, etc.) to each server of the plurality of servers 512.

In some embodiments, each client device of the one or more client devices 514 can provide a user interface to allow a user of the building management system 510 to configure various features, to monitor live or historical operational data, or to perform maintenance tasks related to a client device of the one or more client devices 514 or one or more building subsystems of the plurality of building subsystems 516. In some embodiments, and as shown in FIG. 5, a client device of the one or more client devices 514 includes an integrated user interface (e.g., an arrangement of screens, lights, buttons, and/or other input or output devices by which a user of the building management system 510 may receive information from, or provide inputs to, the client device). In some embodiments, a client device of the one or more client devices 514 is configured to provide a remote user interface on the one or more user devices 534. In some embodiments, a client device of the one or more client devices 514 is configured to host a web browser accessible user interface.

Referring now to FIG. 8, each server of the plurality of servers 512 can include a processing circuit 812 and a communications interface 814. The communications interface 814 may include wired or wireless interfaces (e.g., jacks, antennas, transmitters, receivers, transceivers, wire terminals, etc.) for conducting data communications with various systems, devices, or networks. For example, the communications interface 814 may include an Ethernet card and port for sending and receiving data via an Ethernet-based communications network.

The communications interface 814 may be configured to communicate via local area networks or wide area networks (e.g., the Internet, a building WAN, etc.) and may use a variety of communications protocols (e.g., BACnet, IP, Lon, HTTPS, etc.). Each server of the plurality of servers 512 can be communicably coupled with the other servers of the plurality of servers 512, each client device of the one or more client devices 514, the one or more databases 532, and the one or more user devices 534 by its communications interface 814.

The processing circuit 812 may include one or more processors 816 and a memory 818. The one or more processors 816 can be implemented as one or more general purpose processors, one or more application specific integrated circuits (ASICs), one or more field programmable gate arrays (FPGAs), a group of processing components, or other suitable electronic processing components. The memory 818 (e.g., memory, memory unit, storage device, etc.) can include one or more devices (e.g., RAM, ROM, flash memory, hard disk storage, etc.) for storing data and/or computer code for completing or facilitating the various processes, layers, and modules described in the present disclosure. The memory 818 can be or include volatile memory or non-volatile memory. The memory 818 can include database components, object code components, script components, or any other type of information structure for supporting the various activities and information structures described in the present disclosure. According to some embodiments, the memory 818 is communicably coupled to the one or more processors 816 via the processing circuit 812 and includes computer code for executing (e.g., by the processing circuit 812 or the one or more processors 816) one or more processes described herein.

The memory 818 is shown to include a service manager 820 and a redundancy manager 822. The service manager 820 may operate to provide a plurality of building management services 824. The service manager 820 may manage when and how the plurality of building management services 824 are performed (e.g., the service manager 820 may perform certain building management services in response to receiving a request for the building management services, the service manager 820 may perform certain building management services automatically or periodically, etc.). The service manager 820 may manage dependencies between the plurality of building management services 824 (e.g., may ensure that one or more building management service of the plurality of building management services 824 are started or stopped before other building management services of the plurality of building management services 824). The service manager 820 may monitor and record events related to the performance of the plurality of building management services 824. The service manager may automatically restart a building management service of the plurality of building management services 824 upon determining that the building management service has failed.

The service manager 820 of each server of the plurality of servers 512 may operate the same or similarly. For example, the service manager 820 of a first server of the plurality of servers 512 configured as a primary server may operate to provide the plurality of building management services 824. The service manager 820 of a second server of the plurality of servers 512 configured as a redundant server, or a secondary server may operate to provide redundant instances of the plurality of building management services 824. A third server of the plurality of servers 512 configured as a second redundant server, or a tertiary server may operate to provide second redundant instances of the plurality of building management services 824.

The plurality of building management services 824 can include a service that operates to obtain (e.g., receive, request, acquire) live or historical operational data related to the plurality of building subsystems 516 (e.g., time-series operational data, maintenance data, audit data, etc.) from the one or more client devices 514 and to store and maintain the operational data in one of the one or more databases 532. The plurality of building management services 824 can include a service that operates to monitor the status or health of each of the one or more client devices 514 (e.g., to monitor a heartbeat or heartbeats provided by the one or more client devices 514). The plurality of building management services 824 can include a service that operates to provide alarms to external systems (e.g., via email, SNMP, syslog, etc.) in response to an event (e.g., if the operational data related to a particular building subsystem exceeds a threshold or meets some other triggering condition). The plurality of building management services 824 can include a service that operates to generate scheduled reports of the acquired operational data in accordance with a user or system defined schedule. The plurality of building management services 824 can include a service that operates to forward operating data, control information, configuration data, or other messages between one client device of the one or more client devices 514 and another client device of the one or more client devices 514. In some embodiments, the plurality of building management services 824 can include services operable to perform any of the building management functions or services described in the present application.

The plurality of building management services 824 can include a service that operates to provide a user interface (e.g., on the one or more user devices 534). The user interface may be a web accessible user interface. The user interface can be configured to allow site-wide configuration of the building management system 510, or components thereof. The user interface can allow a user of the building management system 510 to view live or historical operational data related to the plurality of building subsystems 516. The user interface can be configured to enable the creation of control schedules, report generation schedules, or interlock control behaviors. In some embodiments, each server of the plurality of servers 512 can provide an independent user interface. User configuration of, or provided by, the user interface of a server of the plurality of servers 512 can be shared with the other servers of the plurality of servers 512.

The redundancy manager 822 can operate to coordinate the performance of the plurality of building management services 824 by the plurality of servers 512. The redundancy manager 822 of each server of the plurality of servers 512 may transmit a status indicator to the other servers of the plurality of servers 512. The status indicator may be transmitted periodically at a fixed interval (e.g., the status indicator can be a heartbeat). The redundancy manager 822 of each server of the plurality of servers 512 can monitor the status indicator transmitted by every other server of the plurality of servers 512 to determine if the other servers of the plurality of servers 512 are inactive, unavailable, or otherwise offline. The redundancy manager 822 of each server of the plurality of servers 512 may be configured to receive the status indicators transmitted by each other server of the plurality of servers 512, monitor or determine an elapsed time since each status indicator was last received, and determine if each other server of the plurality of servers 512 is inactive based on the elapsed time exceeding a threshold time.

For example, the redundancy manager 822 of a redundant, or secondary server can be configured to receive the status indicator transmitted by the redundancy manager 822 of a primary server, determine an elapsed time since the status indicator transmitted by the redundancy manager 822 of the primary server was last received, and determine the primary server is inactive based upon the elapsed time exceeding a threshold. The redundancy manager 822 of a second redundant, or tertiary server can be configured to receive the status indicator transmitted by the redundancy manager 822 of a primary server and the status indicator transmitted by the redundancy manager 822 of the secondary server, determine a first elapsed time since the status indicator transmitted by the redundancy manager 822 of the primary server was last received and a second elapsed time since the status indicator transmitted by the redundancy manager 822 of the secondary server was last received, and determine the primary server is inactive based on the first elapsed time exceeding a threshold and determine the secondary server is inactive based on the second elapsed time exceeding the threshold.

The redundancy manager 822 of redundant servers of the plurality of servers 512 can operate a suppressor 826 to suppress (e.g., prevent from being generated, prevent from being transmitted, etc.) one or more outputs of the redundant instances of the plurality of building management services 824 provided by the redundant servers of the plurality of servers 512. The one or more outputs suppressed by the suppressor 826 can include a scheduled report, an alarm to an external system, and/or a message, a configuration, or data to be forwarded between a first client device of the one or more client devices 514 and a second client device of the one or more client devices 514. The suppressor 826 can suppress the one or more outputs by preventing the performance of the building management services of the plurality of building management services 824 that generate the one or more outputs.

The redundancy manager 822 of redundant servers of the plurality of servers 512 can operate the suppressor 826 to unsuppress the one or more outputs of the redundant instances of the plurality of building management services 824 provided by the redundant servers in response to determining each precedential server of the plurality of servers 512 are inactive. For example, the redundancy manager 822 of a redundant server, or a secondary server of the plurality of servers 512 can operate the suppressor 826 to unsuppress the one or more outputs of the redundant instances of the plurality of building management services 824 provided by the secondary server in response to determining that a primary server is inactive. The redundancy manager 822 of a second redundant server, or a tertiary server of the plurality of servers 512 can operate the suppressor 826 to unsuppress the one or more outputs of the second redundant instances of the plurality of building management services 824 provided by the tertiary server in response to determining that a primary server and a secondary server are both inactive. The suppressor 826 can unsuppress the one or more outputs by allowing the performance of the building management services of the plurality of building management services 824 that generate the one or more outputs.

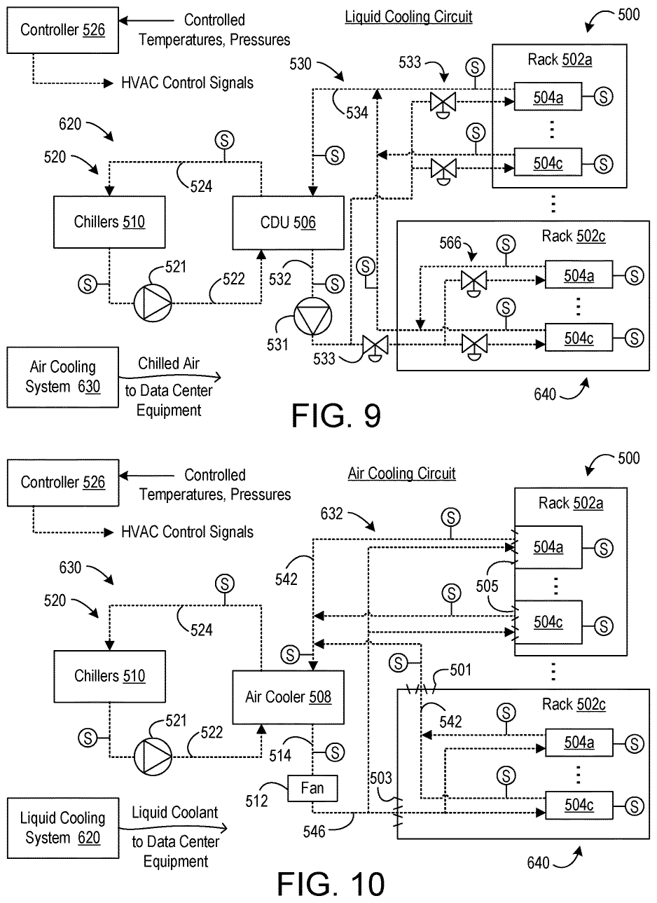

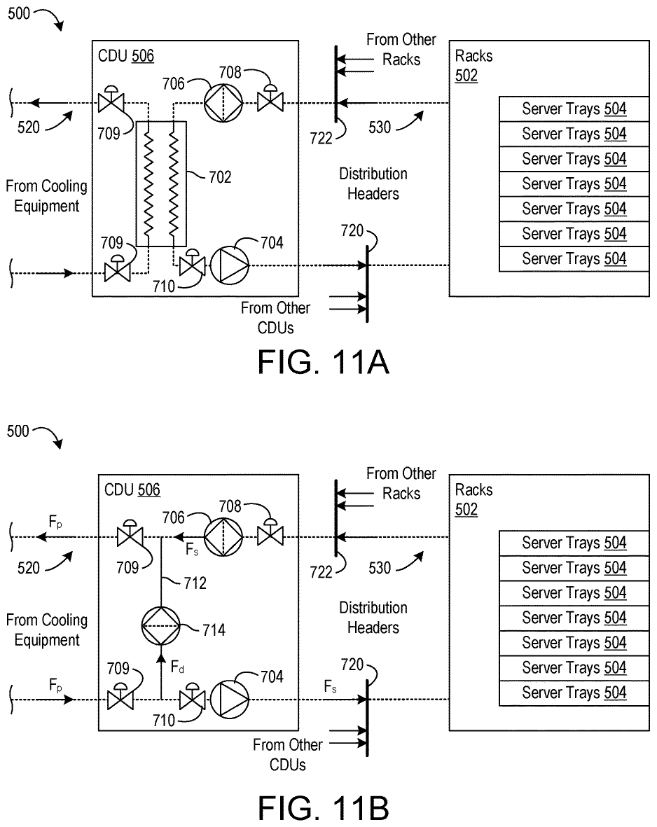

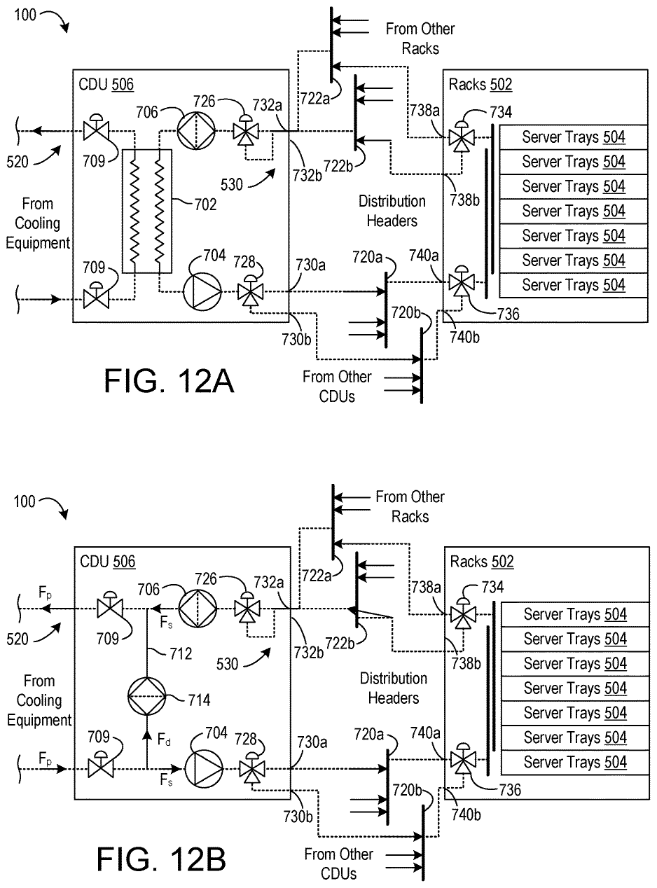

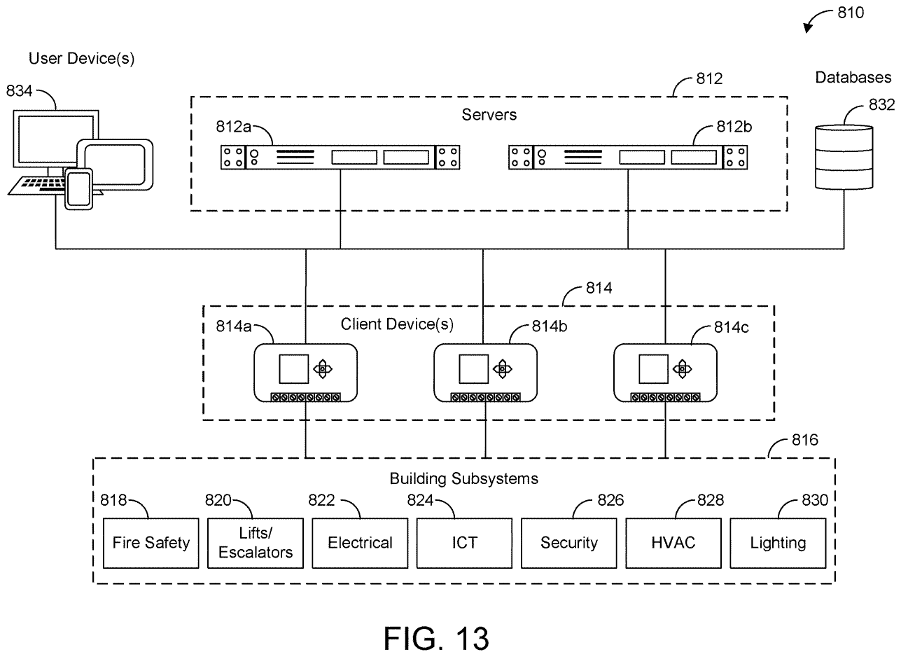

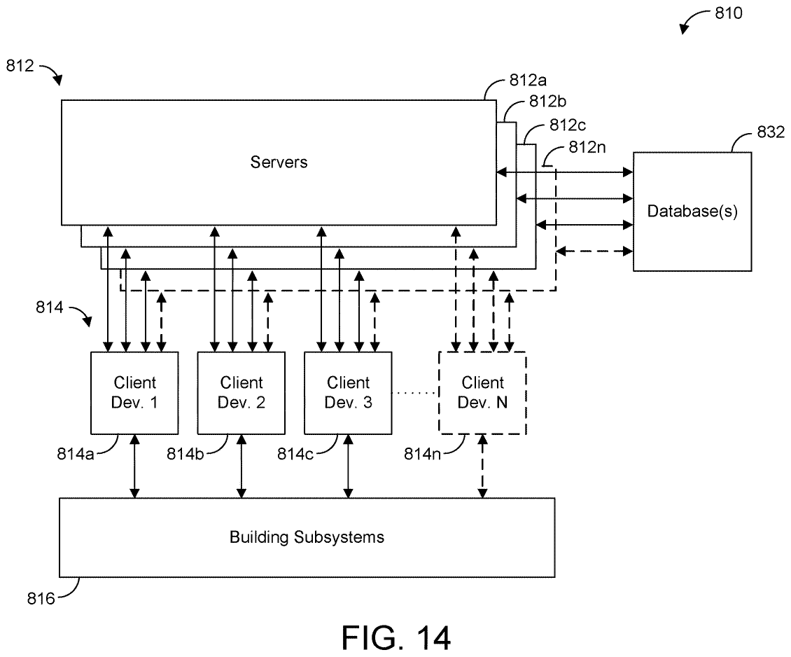

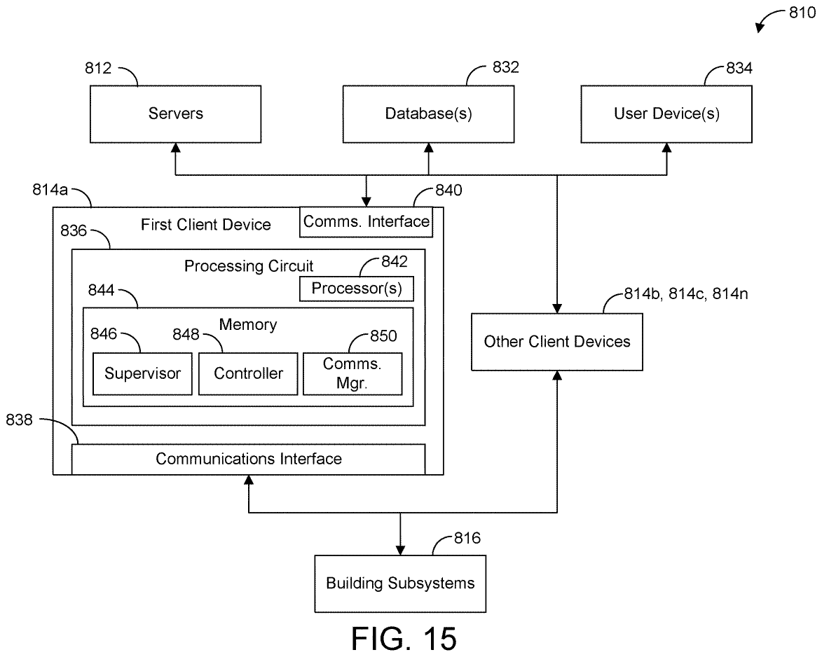

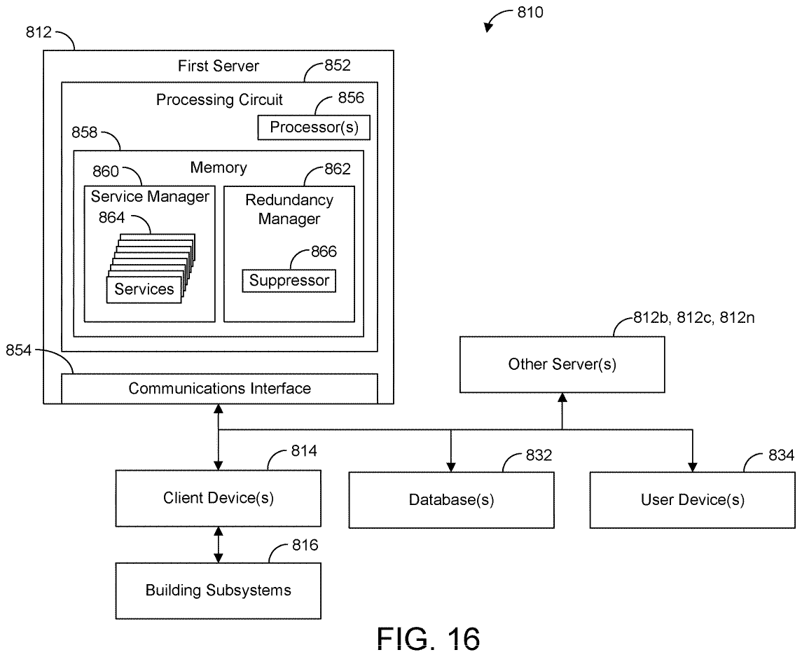

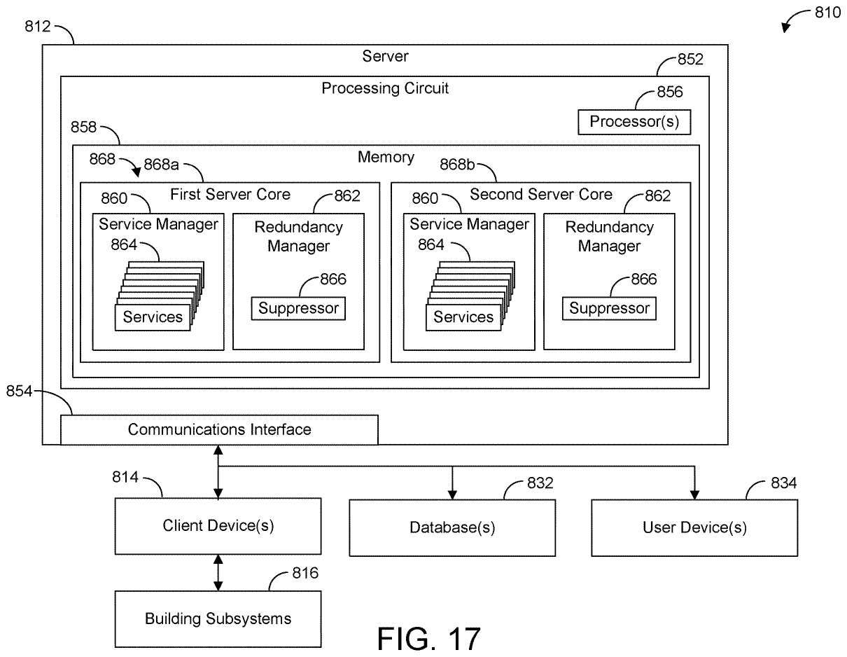

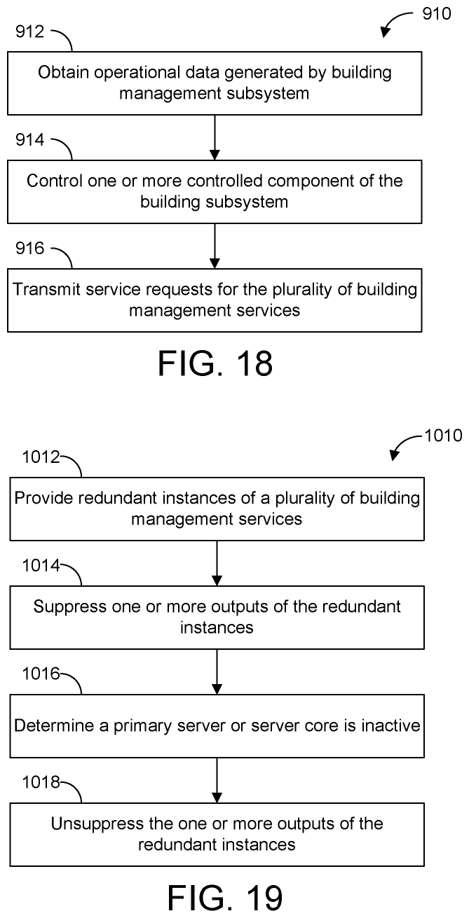

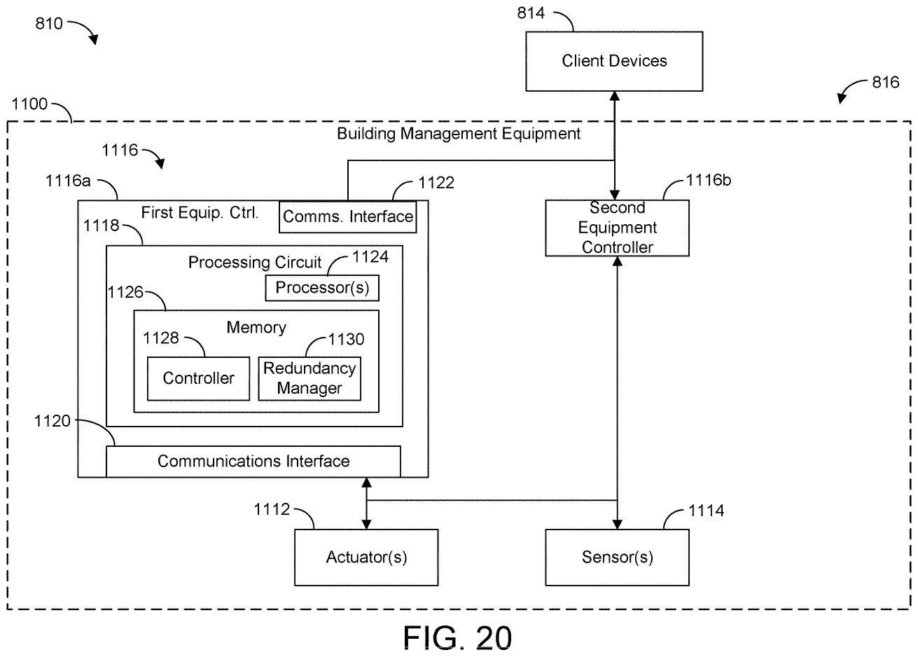

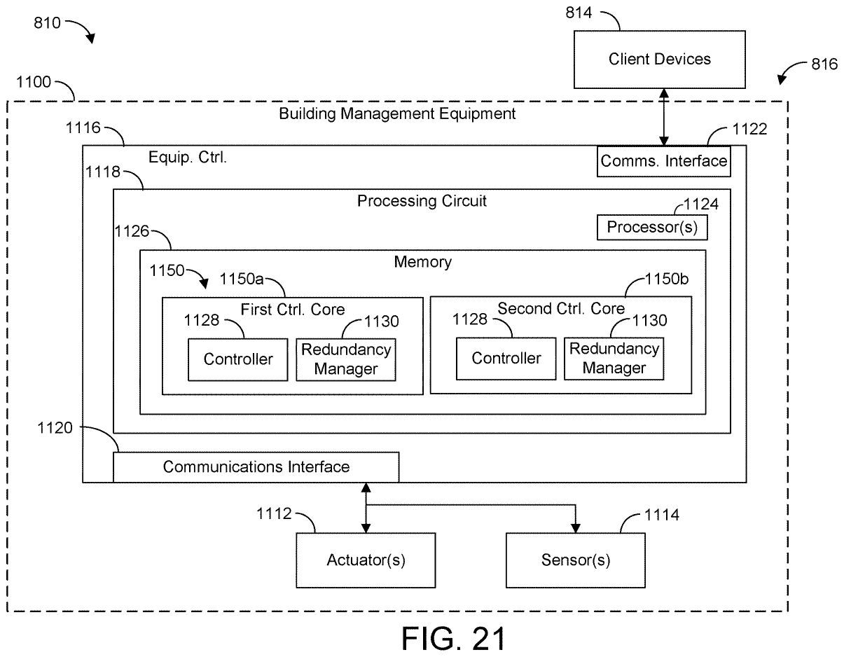

Referring to FIG. 9, a flow diagram of a process 910 for supervising and controlling building subsystems is provided, according to some embodiments. The process 910 may be implemented by a client device of the one or more client devices 514 and will therefore be described with reference to FIG. 7. However, any computing device described herein can be configured to perform the process 910. In other embodiments, the process 910 may include additional, fewer, and/or different steps or operations.

In some embodiments, the process 910 includes obtaining operational data generated by a building subsystem configured to affect a condition of a building at operation 912. The operation 912 may be performed by the supervisor 722. The building subsystem may be one of the plurality of building subsystems 516 communicably coupled with the client device. In some embodiments, the supervisor 722 may request the operational data from a controller of the building subsystem (e.g., transmit a request to the controller of the building subsystem to transmit measured, calculated, or aggregated operating data to the client device). In some embodiments, the supervisor may receive sensor data associated with the building subsystem. The supervisor may analyze the operational data received to determine if a fault condition is present or whether a threshold or interlock condition is met. The client device can repeat the operation 912 for each building subsystem communicably coupled with the client device to obtain operational data generated by each building subsystem communicably coupled to the client device.

In some embodiments, the process 910 includes controlling one or more controlled component of the building subsystem to affect the condition of the building, at operation 914.

The operation 914 may be performed by the controller 724. In some embodiments, the controller 724 may transmit a set point or control command to the controller of the building subsystem to cause the controller to alter the manner in which the building subsystem is operating. In some embodiments, the controller 724 may transmit control signals directly to an actuator (e.g., a motor, a solenoid, a linear actuator, etc.) to alter the manner in which the building subsystem is operating. The client device may perform the operation 914 in response to determining, at the operation 912, that a fault condition, a threshold condition, or an interlock condition has been met. Additionally, or alternatively, the client device may perform the operation 914 upon receiving a request from a server of the plurality of servers 512.

In some embodiments, the process 910 includes transmitting service requests for one of a plurality of building management services to a plurality of servers, at operation 916. The operation 916 may be performed by the communications manager 726. The plurality of servers may be the plurality of servers 512, each configured to provide the plurality of building management services 824. The communications manager can send duplicate service requests for the plurality of building management services 824 to each of the plurality of servers 512. The service requests may be accompanied by the operational data obtained at the operation 912. For example, after obtaining the operation data at operation 912, the client device may request that the plurality of servers 512 archive the data (e.g., in the databases 532).

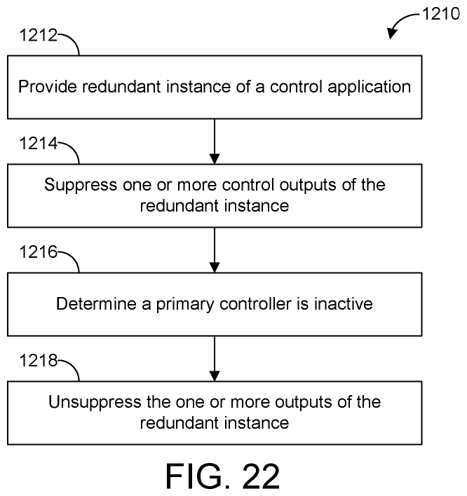

Referring to FIG. 10, a flow diagram of a process 1010 for providing high availability building management services is provided. The process 1010 may be implemented by a server of the plurality of servers 512 and will therefore be described with reference to FIG. 7. However, any computing device described herein can be configured to perform the process 1010. In other embodiments, the process 1010 may include additional, fewer, and/or different steps or operations.

In some embodiments, the process 1010 includes providing redundant instances of a plurality of building management services at operation 1012. The operation 1012 can be performed by the service manager 820 and the plurality of building management services can be the plurality of building management services 824. When performed by a server configured as a redundant, or secondary server, the operation 1012 includes providing redundant instances of the plurality of building management services 824 concurrently with a primary server. When performed by a server configured as a second redundant server, or a tertiary server, the operation 1014 includes providing second redundant instances of the plurality of building management services 824 concurrently with the primary server and the secondary server. Operation 1012 may be performed in response to receiving a request for the plurality of building management services 824 (e.g., from a client device of the one or more client devices 514, from a user device of the one or more user devices, etc.). In some embodiments, operation 1012 is performed routinely, periodically, or according to a schedule.

In some embodiments, the process 1010 includes suppressing one or more outputs of the redundant instances of the plurality of building management services at operation 1014. The operation 1014 can be performed by the redundancy manager 822 and the suppressor 826. When performed by the secondary server, the operation 1014 can include suppressing one or more outputs of the redundant instances of the plurality of building management services 824. When performed by the tertiary server, the operation 1014 can include suppressing the one or more outputs of the second redundant instances of the plurality of building management services. The one or more outputs suppressed can include outputs that may result in discordant or undesirable behavior if duplicated. The one or more outputs suppressed can include a scheduled report, an alarm or notification to a system external to the building management system 510, or data, messages, or configurations being transmitted to or between client devices.

In some embodiments, the process 1010 includes determining a primary server is inactive at operation 1016. The operation 1016 may be performed by the redundancy manager 822. When performed by a redundant server (e.g., the secondary server, the tertiary server, etc.), the operation 1016 may include receiving a status indicator periodically transmitted by the primary server. When performed by a redundant server, the operation 1016 may include determining an elapsed time since last receiving the status indicator and determining the primary server is inactive in response to the elapsed time exceeding a threshold time. Operation 1016 can additionally include transmitting an alert (e.g., to the one or more client device 514, to an external system, to the other servers of the plurality of servers 512, etc.) in response to determining the primary server is inactive. When performed by a tertiary server, the operation 1016 may include receiving a status indicator periodically transmitted by the secondary server. When performed by the tertiary server, the operation 1016 may include determining an elapsed time since last receiving the status indicator and determining the secondary server is inactive in response to the elapsed time exceeding a threshold time. Operation 1016 can additionally include transmitting an alert (e.g., to the one or more client device 514, to an external system, to the other servers of the plurality of servers 512, etc.) in response to determining the secondary server is inactive.

In some embodiments, the process 1010 includes unsuppressing the one or more outputs of the redundant instances of the plurality of building management services, performed at operation 1012, at operation 1018. The operation 1018 may be performed by the redundancy manager 822 and the suppressor 826. When performed by the secondary server, operation 1018 can include unsuppressing the one or more outputs of the redundant instances of the plurality of building management services 824 suppressed at operation 1014. When performed by the tertiary server, operation 1018 can include unsuppressing the one or more outputs of the second redundant instances of the plurality of building management services 824 suppressed at operation 1014. Unsuppressing the one or more outputs can include allowing the building management services of the plurality of building management services 824 that produce the one or more outputs to be performed.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building management system, comprising:
a first server configured to provide a plurality of building management services;
a second server communicably coupled to the first server, the second server configured to:
provide redundant instances of the plurality of building management services while suppressing one or more outputs of the redundant instances;
determine the first server is inactive; and
unsuppress the one or more outputs of the redundant instances in response to determining the first server is inactive; and
a client device communicably coupled to the first server and the second server, the client device configured to transmit service requests for the plurality of building management services to the first server and the second server.

2. The building management system of claim 1, wherein the client device is configured to obtain operational data generated by a building management subsystem operable to affect one or more conditions of a building.

3. The building management system of claim 2, wherein the client device is building equipment operable to control one or more controlled components of the building management subsystem to affect the one or more conditions of the building.

4. The building management system of claim 1, wherein:
the first server is further configured to periodically transmit to the second server a status indicator; and
the second server is further configured to:
receive the status indicator;
determine an elapsed time since the status indicator was received; and
determine the first server is inactive based on the elapsed time exceeding a threshold.

5. The building management system of claim 4, wherein the second server is further configured to transmit an alert to a user device in response to determining the first server is inactive.

6. The building management system of claim 1, wherein the plurality of building management services includes at least one of providing a user interface on a user device, monitoring a status of the client device, receiving historical data from the client device, providing alarms to an external system, generating a scheduled report, or configuring the client device.

7. The building management system of claim 1, wherein the one or more outputs include at least one of a scheduled report, an alarm to an external system, or a client device configuration.

8. The building management system of claim 1, further comprising:
a third server communicably coupled with the first server, the second server, and the client device, the third server configured to:
provide second redundant instances of the plurality of building management services while suppressing one or more outputs of the second redundant instances;
determine the first server and the second server are inactive; and
unsuppress the one or more outputs of the second redundant instances in response to determining the first server and the second server are inactive.

9. A method of providing high availability building management, the method comprising:
providing redundant instances of a plurality of building management services at a secondary server concurrently with a primary server;
suppressing one or more outputs of the redundant instances at the secondary server;
determining the primary server is inactive; and
unsuppressing the one or more outputs of the redundant instances at the secondary server in response to determining the primary server is inactive.

10. The method of claim 9, wherein determining the primary server is inactive includes:
receiving a status indicator from the primary server;
determining an elapsed time since receiving the status indicator from the primary server; and
determining the primary server is inactive in response to the elapsed time exceeding a threshold time.

11. The method of claim 10, further comprising transmitting, to a user device, an alert in response to determining the primary server is inactive.

12. The method of claim 10, wherein the plurality of building management services includes at least one of providing a user interface to a user device, providing alerts to the user device, monitoring a status of a client device, receiving historical data from the client device, providing an alarm to an external system, generating a scheduled report, or configuring the client device.

13. The method of claim 10, wherein the one or more outputs include at least one of an alarm to an external system, a scheduled report, or a client device configuration.

14. A building management system, comprising a secondary server comprising one or more processors and memory storing instructions, that when executed by the one or more processors, cause the one or more processors to perform first operations comprising:
providing redundant instances of a plurality of building management services concurrently with a primary server;
suppressing one or more outputs of the redundant instances;
determining the primary server is inactive; and
unsuppressing the one or more outputs of the redundant instances in response to determining the primary server is inactive.

15. The building management system of claim 14, wherein determining the primary server is inactive includes:
receiving a status indicator from the primary server;
determining an elapsed time since receiving the status indicator from the primary server; and
determining the primary server is inactive in response to the elapsed time exceeding a threshold time.

16. The building management system of claim 15, the first operations comprising transmitting, to a user device, an alert in response to determining the primary server is inactive.

17. The building management system of claim 14, wherein the plurality of building management services includes at least one of providing a user interface to a user device, providing alerts to the user device, monitoring a status of a client device, receiving historical data from the client device, providing an alarm to an external system, generating a scheduled report, or configuring the client device.

18. The building management system of claim 14, wherein the one or more outputs include at least one of an alarm to an external system, a scheduled report, or a client device configuration.

19. The building management system of claim 14, further comprising a client device comprising one or more processors and memory storing instructions that, when executed by the one or more processors, cause the one or more processors to perform second operations comprising transmitting service requests for the plurality of building management services to the primary server and the secondary server.

20. The building management system of claim 19, wherein the second operations include:
obtaining operational data generated by a building management subsystem configured to affect one or more condition of a building; and
controlling one or more controlled component of the building management subsystem to affect the one or more condition of the building.
